(19) United States
(12) Patent Application Publication
(10) Pub. No.: US 2009/0092827 A1
(43) Pub. Date: Apr. 9, 2009

(54) POLYMERIC MATERIALS

(75) Inventor: John Robinson, Thornton Cleveleys, Lancashire (GB)

Correspondence Address: MICHAEL BEST & FRIEDRICH LLP, 100 E WISCONSIN AVENUE, Suite 3300, MILWAUKEE, WI, 53202, US

(73) Assignee: VICTREX MANUFACTURING LIMITED, Thornton Cleveleys, Lancashire (GB)

(21) Appl. No.: 12/299,022

(22) PCT Filed: May 1, 2007
(86) PCT No.: PCT/GB07/01580

§ 371 Date: Oct. 30, 2008

(30) Foreign Application Priority Data
May 2, 2006 (GB) 0608560.9
Aug. 11, 2006 (GB) 0615996.6

(51) Int. Cl. B32B 27/32; B32B 27/00; C09D 171/10; C09D 127/12

(52) U.S. Cl. 428/341; 428/421; 525/153

(57) ABSTRACT

An assembly comprises a part for example a part of an item of cookware, bakeware, domestic appliance or the like which is subjected to a wear means in use such that the wear means may abrade the outer surface of the part. The part is provided with an outer surface which comprises a polyaryletherketone polymer, especially polyetheretherketone, and a fluoropolymer. Such a combination is found to exhibit superior wear properties over other known materials.

This invention relates to polymeric materials and particularly, although not exclusively, relates to polymeric materials which define a surface of a part, for example polymeric materials which may define a coating on a substrate.

It is well known to provide parts with coatings to address various problems. For example coatings may be provided to improve wear properties of parts which are contacted in use by, for example, an abrasive fluid or a solid body.

Fluoropolymers are widely used in coating materials. However, disadvantageously, a primer is generally required to enable a fluorocarbon layer to adhere to a substrate. Furthermore, parts coated with fluoropolymers have relatively poor wear properties and as a result the coatings may wear through to reveal the underlying substrate after a relatively short time. Whilst the problem has been addressed by providing multiple coating layers, the provision of such layers increases the cost of coating parts.

Polyetheretherketone has been proposed for use in coating materials. Polyetheretherketone generally performs better than fluoropolymers but still wears significantly over time usually where high loads are used.

It is an object of the present invention to address the above described problems.

According to a first aspect of the invention, there is provided an assembly comprising a part arranged to be contacted by wear means in use such that said wear means has a tendency to apply an abrasive force to an outer surface of said part, wherein said outer surface of said part comprises a composition which comprises a polyaryletherketone polymer and a fluoropolymer.

Said polyaryletherketone polymer preferably comprises, more preferably consists essentially of, a repeat unit of formula

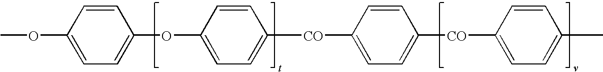

where t and v independently represent 0 or 1. Preferred polymeric materials have a said repeat unit wherein either t=1 or v=0; t=0 and v=0; or t=0 and v=1. More preferred have t=1 and v=0; or t=0 and v=0. The most preferred has t=1 and v=0.

In preferred embodiments, said polyaryletherketone polymer is selected from polyetheretherketone, polyetherketone, polyetherketoneketone and polyetherketoneether ketoneketone. In a more preferred embodiment, said polyaryletherketone polymer is selected from polyetherketone and polyetheretherketone. In an especially preferred embodiment, said polyaryletherketone polymer is polyetheretherketone.

Said polyaryletherketone polymer material may have a melt viscosity (MV) in the range 0.05 to 0.7 kNsm⁻², preferably in the range 0.06 to 0.7 kNsm⁻², more preferably in the range 0.14 to 0.5 kNsm⁻², especially in the range 0.3 to 0.5 kNsm⁻².

MV is suitably measured using capillary rheometry operating at 400° C. at a shear rate of 100 s⁻¹ using a tungsten carbide die, 0.5×3.175 mm.

Said fluoropolymer preferably comprises a fluorocarbon resin which may be selected from perfluoroalkoxy tetrafluoroethylene (PFA), polytetrafluoroethylene (PTFE) and tetrafluoroethylene-hexafluoropropylene copolymer resin (FEP).

A perfluoroalkoxy polymer (herein referred to as PFA) may be represented by the following general formula:

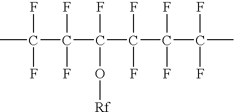

wherein Rf is a fluoroalkyl group (so —O—Rf is a perfluoroalkoxy group). PFA has a melting point of from 302 to 310° C., exhibits melt fluidity at temperatures above the melting point thereof, has high heat resistance and chemical resistance, has a continuous services temperature of 260° C., and is little affected by the usual acids, alkalis, oxidation-reduction agents, halogens, and organic solvents.

PFA is sold under the trade name of Teflon PFA by E.I. Du Pont de Nemours & Co., Inc., U.S.A. and Mitsui Fluorochemicals Co., Ltd., Japan.

A tetrafluoroethylene/hexafluoropropylene copolymer (herein referred to as FEP) may be represented by the following general formula:

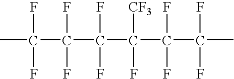

FEP has a melting point of from 250 to 290° C., exhibits melt fluidity at temperatures more than the melting point thereof, has high heat resistance and chemical resistance, and has a continuous service temperature of 200° C.

FEP is commercially available from E.I. Du Pont de Nemours & Co., Inc., U.S.A. (trade mark: Teflon FEP) and Daikin Kogyo Co., Ltd. (trade name: Neofuron). Among commercially available FEPs, those copolymers having a hexafluoropropylene content of from 18 to 25% by weight are preferably used.

Said fluoropolymer is preferably selected from PFA and PTFE. More preferably, it is PFA. The ratio of the wt % of polyaryletherketone to the wt % of fluoropolymer in said composition at said outer surface is suitably at least 1, is preferably at least 1.5, is more preferably at least 2 and, especially, is at least 2.5. Said ratio is suitably less than 50, preferably less than 25, more preferably less than 15, especially less than 10. In preferred embodiments, the ratio is in the range of 2 to 9, preferably 2 to 7.

The composition at said outer surface suitably includes at 5 least 40 wt %, preferably at least 50 wt %, more preferably at least 60 wt % of said polaryletherketone. Said composition may include 95 wt % or less of said polyaryletherketone.

The composition of said outer surface suitably includes at least 5 wt %, preferably at least 10 wt %, more preferably at least 15 wt %, especially at least 20 wt %, of said fluoropolymer.

The composition of said outer surface suitably includes 70 to 95 wt % of said polyaryletherketone (especially polyetheretherketone) and 15 to 30 wt % of said fluoropolymer (especially PFA).

Said part may include at least 1 mg, suitably at least 10 mg, preferably at least 500 mg, more preferably at least 1 g of said composition.

In one embodiment, a substantial volume of said part may be made up of said composition. For example, greater than 50%, suitably greater than 60%, preferably greater than 70%, more preferably greater than 80% of said part may be made up of said composition. Substantially the entirety of said part may be made up of said composition. In this case, said part may be moulded, for example injection moulded, from said composition.

In other embodiments, said part may comprise a layer of said composition which layer defines said outer surface of said part.

Said layer preferably comprises a substantially homogenous mixture of said polyaryletherketone and said fluoropolymer.

Said layer suitably covers an area of at least 1 cm², preferably at least 5 cm², more preferably at least 10 cm². It may cover an area of less than 1 m², preferably less than 0.5 m².

Said layer may have a coat weight of at least 1.0 mg/cm², preferably at least 1.2 mg/cm². The coat weight may be less than 20 mg/cm². In one embodiment (e.g. where a process using powders is utilised to prepare the layer) the coat weight may be at least 5 mg/cm².

Said layer may include at least 1.0 mg, preferably at least 1.2 mg of said polyaryletherketone per cm² of said layer. Said layer may include less than 20 mg of said polyaryletherketone per cm² of said layer.

Said layer may have a minimum thickness (measured across its whole extent) of Sum, preferably of at least 8 μm.

Said layer may have a maximum thickness (measured across its whole extent) of less than 100 μm, preferably less than 500 μm, more preferably less than 250 μm, especially less than 150 μm.

Said layer may have an average thickness measured over its whole extent in the range 10 to 1000 μm, preferably 10 to 150 μm.

Said minimum/maximum thicknesses may be measured using a Sheen Eco Test Plus BFN Coating Thickness Gauge Type 121-17-00 from Sheen Instruments Ltd.

Said layer may have a total weight of at least 1 mg, preferably at least 5 mg, more preferably at least 10 mg, especially at least 1 g.

Said layer may include at least 1 mg, preferably at least 10 mg, especially at least 1 g of said polyaryletherketone.

Said part may include at least 10 mg, preferably at least 500 mg, especially at least 1 g of said polyaryletherketone.

Said layer preferably includes at least 10 mg, preferably at least 500 mg, especially at least 1 g of said polyaryletherketone.

Said part may be for an item of cookware, bakeware, domestic appliance, industrial apparatus or automotive application. It may be a compressor part, piston, liner, piston ring, sealing gasket, valve, impeller, conveyor belt material, seal (or the like). Said part may comprise any type of bearing surface.

When said part comprises a layer of said composition said layer may be provided on a substrate, suitably so that it contacts said substrate. Said substrate could itself include a layer of a coating material, for example having a composition as described herein. Said substrate may be flexible or rigid. Said substrate may comprise a fabric which may be woven or non-woven. For example, a said fabric may comprise a glass or carbon-fibre containing fabric. Said substrate may comprise a pressure-sensitive tape. Preferably, said substrate comprises a metal which may be selected from steel (including stainless steel), aluminium, copper and iron, including cast versions of any of the aforesaid.

The part may have a weight of at least 1 g, preferably at least 5 g, more preferably at least 10 g. The weight may be less than 10 kg, preferably less than 1 kg.

A layer as described may define internal or external surfaces of a said part. For example in the case of a receptacle, for example for cookware, it may coat internal and external surfaces thereof. Preferably, said layer defines a surface of said part which is subject to significant abrasive force, in use.

Said layer may be in direct contact with a metal surface of said part. Thus, advantageously, said layer may adhere to said metal surface without the use of a primer.

Said part may include a multiplicity of layers each of which may include a polyaryletherketone polymer and a fluoropolymer as described. Each of said layers may independently have any feature of the layer described herein. The coated part may include other coating layers which do not include said polyaryletherketone and fluoropolymer.

Said wear means may comprise an abrasive fluid which contacts said outer surface of said part or a solid body which contacts said outer surface. Where said wear means comprises an abrasive fluid, said fluid may comprise abrasive particles, for example a fluidic slurry. For example, in one embodiment, said outer surface of said part may be an internal surface of a pump which is contacted in use by a fluidic slurry comprising sand/grit particles. In another embodiment, said outer surface may comprise industrial cookware for example a dough machine or other industrial mixer wherein said cookware item is for containing an abrasive fluid such as fluids containing icing sugar, marzipan or other abrasive materials. In a further embodiment, said outer surface of said part may be a load carrying surface of a conveyor belt, wherein said belt comprises a fabric which is provided with a layer as described.

When said wear means comprises a solid body, said solid body may comprise a part made out of a metal or plastics material or other composite material. Said solid body is preferably arranged in said assembly to follow a substantially predetermined travel path wherein it contacts said part and applies an abrasive force thereto in use. Said solid body may be arranged to move relative to said part, suitably between predetermined first and second positions. Said solid body may be arranged to slide between first and second positions; for example it may contact and slide over said part. Alternatively, said part may be pivotally mounted.

According to a second aspect of the invention, there is provided a method of manufacturing a part of an assembly which is arranged to be subjected to a wear means in use such that said wear means has a tendency to apply an abrasive force to an outer surface of said part, said method comprising providing said part with an outer surface which comprises a composition which comprises a polaryletherketone polymer and a fluoropolymer.

Said method may comprise selecting a precursor composition which comprises a mixture of said polyaryletherketone polymer and said fluoropolymer and forming said part from said precursor composition. In one embodiment, wherein a substantial volume of said part is made of said composition as described above, the manufacture of said part may include a step of moulding (eg by injection moulding or extrusion) said precursor composition. In another embodiment wherein said part comprises a layer of said composition, said method may comprise contacting a substrate with said precursor composition. In this case, said precursor composition may comprise a dispersion of polyaryletherketone and fluoropolymer or said polyaryletherketone and fluoropolymer may be provided in a dry powderous form.

When said part comprises a layer of said composition, a layer applied may be lapped to define said outer surface of said part. Preferably, however, a layer applied is not lapped and/or otherwise contacted with a solid body to define said outer surface.

According to a third aspect of the invention, there is provided a part for an assembly, said part being arranged to be contacted in use by a wear means such that said wear means has a tendency to apply an abrasive force to an outer surface of said part to abrade it, wherein said outer surface of said part comprises a composition which comprises a polyaryletherketone polymer and a fluoropolymer.

According to a fourth aspect, there is provided the use of a composition which comprises a polyaryletherketone polymer and a fluoropolymer in the manufacture of a part which is contacted by a wear means in use which wear means has a tendency to apply an abrasive force to an outer surface of said part to abrade it.

According to a fifth aspect, there is provided a method of operating an assembly which comprises a part having an outer surface which comprises a composition which comprises a polyaryletherketone polymer and a fluoropolymer, said method comprising contacting a wear means with said outer surface of said part wherein said wear means applies an abrasive force to said outer surface.

The outer surface of said part may be subjected to a temperature of at least −60° C., or even 100° C., or even 150° C., or even 200° C., or even 260° C., during contact thereof by said wear means.

According to a sixth aspect, there is provided an operative assembly comprising a part which is contacted with a wear means which applies an abrasive force to an outer surface of said part, wherein said outer surface of said part comprises a composition which comprises a polyaryletherketone polymer and a fluoropolymer.

Any feature of any aspect of any invention or embodiment described herein may be combined with any feature of any other aspect of any invention or embodiment described herein mutatis mutandis.

Specific embodiments of the invention will now be described, by way of example, with reference to the accompanying figures, in which:

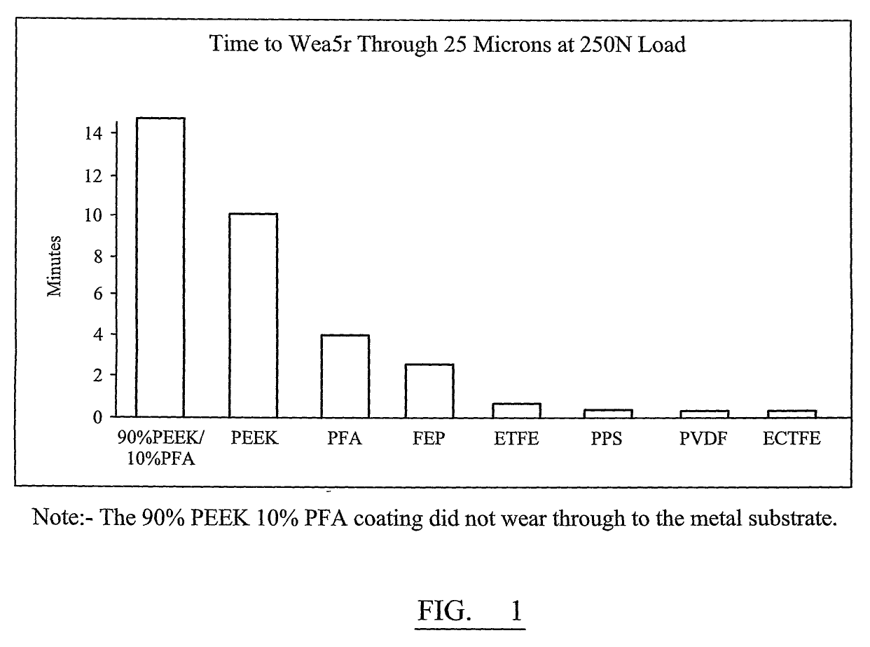

FIG. 1 is a graphical representation of the wear rates of various coatings; and

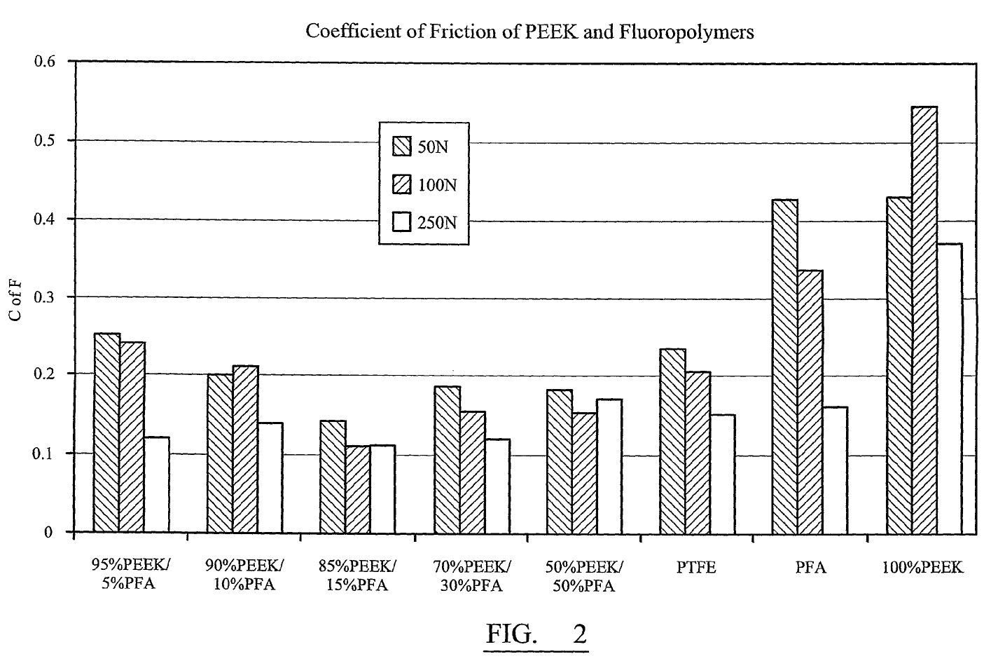

FIG. 2 is a graphical representation of the coefficient of friction of various coatings under different loads.

The following materials are referred to hereinafter.

Polyetheretherketone powder having a melt viscosity of 0.15 kNsm⁻² and a D₅₀ of 10 μm obtained from Victrex Plc, UK, (referred to herein as “PAEK No.1”)

Aerosol® OT75%E—a surfactant from Cytec Industries UK Ltd comprising a mixture of sodium dioctyl sulphosuccinate (73-75% wt), ethanol (6-7% wt) and water.

PFA 5011—refers to a PFA sold under the trade mark TEFLON by DUPONT comprising, nominally, 10 μm powder.

ZONYL MP1400—a PTFE in powder form obtained from DUPONT.

RYTON—a PPS sold by Chevron Phillips Chemical Company;

ETFE—a powder coating grade of ethylene tetrafluoroethylene;

PVDF—a powder coating grade of polyvinylidene fluoride;

OXPEKK—a polyetherketoneketone obtained from Oxford Polymers;

ECTFE—a powder coating grade of ethylene chloro-trifluoroethylene.

### EXAMPLE 1

### Preparation of Polyetheretherketone/PFA dispersion

A plastic 5000 ml beaker was charged with demineralised water (1.45 kg) and to it was added slowly, with stirring, the surfactant, Aerosol OT75 E (100 g). When the mixture was homogeneous PAEK No.1 (0.9 kg) was added slowly. Stirring was continued until the polymer had been fully incorporated. Thereafter PFA 5011 (0.1 Kg) was added slowly and incorporated by stirring.

The beaker was placed under a high shear Silverson laboratory mixer with an emulsion head stirrer attachment. The speed of the mixer was slowly increased to 3000 rpm and maintained at that speed for 5 minutes. There was minimal foaming of the sample.

### EXAMPLE 2

### (Comparative)—Preparation of Polyetheretherketone Dispersion.

The procedure described in Example 1 was generally followed except that the step of adding PFA was omitted so that an aqueous dispersion of polyetheretherketone was prepared.

### EXAMPLE 3

### Preparation of Polyetheretherketone/PTFE Dispersion

The procedure described in Example 1 was generally followed except that PTFE in the form of ZONYL MP1400 was added instead of the PFA 5011.

### EXAMPLE 4

### Preparation of Substrates for Coating

The substrates were 60 mm×37 mm×3 mm 316 stainless steel grit blasted with an aluminium oxide grade with a mean particle size of 425-600 microns. The grit blasted surface had a profile with a Ra and Rz value of 1.83 microns and 1.73 microns respectively.

### EXAMPLES 5a and 5b

### General Method for Coating of Substrates

Substrates prepared as described in Example 4 were coated as described in Example 5a if an aqueous dispersion was used or as described in Example 5b if a powder was used.

### EXAMPLE 5a

### Dispersion Coating

The coating gun used was a Devilbiss, type SRIW, with a tip size of 0.7-1.0 mm. Air pressure to the gun was 30 to 40 psi depending on what type of coating was required i.e. wet, dry, thin or thick coating. Procedure for coating: A dispersion to be coated was hand mixed with a stirrer rod before pouring into the spray gun reservoir. The substrate to be coated was placed in an air extracted spraying cabinet and two or three wet coats applied. The substrate was then left to dry in air for 5 minutes then placed in an air circulated oven set to 120° C. to flash off the remaining water. The substrate was then placed for 10 minutes in an oven set to 390° C.-420° C. to melt and flow the coating. After removal from the oven the substrates were cooled to room temperature.

### EXAMPLES 5b

### Powder Coating

The powder for coating was dried in an oven at 150° C. for 3 hours before use. The substrate to be spray coated was placed in an oven at 400° C. for 10 minutes, removed from the oven and quickly sprayed with the powder. The powder melted on contact with the substrate. The coated substrate was placed in the oven at 400° C. for 10 minutes to melt and flow the coating. The substrate was removed from the oven and allowed to cool.

### EXAMPLE 6

The method of Example 5a was used to prepare coatings as described in Table 1 below:

TABLE 1

| | | | Dry Film |
|---|---|---|---|
| Example | | | Thickness of |
| No | Polymer(s) coated | Method used | coating (μm) |
| 6a | PAEK No. 1/PFA5011 | Example 5a | 52 |
| | (90 wt %/10 wt %) | | |
| 6b | Polyetheretherketone | Example 5a | 53 |
| | PAEK No. 1 | | |
| 6c | PFA5011 | Example 5a | 190 |

### EXAMPLE 7

### Assessment of Coefficient of Friction of Coatings

The coatings described in Example 6 were evaluated by Coefficient of Friction testing using ASTM G133-05. The test assessed the Coefficient of Friction measured at 3 loads (50, 100 and 250N) on a Plint TE77 test rig using a 10 mm slider @ 20Hz with a stroke of 10 mm.

The test method uses a linear reciprocating ball on a flat plane geometry. The direction of the relative motion between sliding surfaces reverses in a periodic fashion such that the sliding occurs back and forth in a straight line. In the assessments, the specimens were un-lubricated.

The wear scars from the assessment were examined. It was observed that the coating of Example 6a resists wear well; only a wear scar was visible and there was no penetration through to the underlying substrate. This is in contrast to the results for Examples 6b and 6c which showed significant penetration of the coating through to the substrate, although the Example 6b coating resisted wear better than that of Example 6c. Table 2 summarises the results of the assessments undertaken.

TABLE 2

| Material | Coefficients of friction | | | |
|---|---|---|---|---|
| of Example | under specified loads | | | |
| No | 50N | 100N | 250N | Comments |
| 6b | 0.42 | 0.53 | 0.37 | Penetrated coating at |
| | | | | 250N after 20 minutes. |
| 6c | 0.42 | 0.33 | 0.16 | Wears through to |
| | | | | substrate at 100 and |
| | | | | 250N in 20 minutes. |
| 6a | 0.20 | 0.21 | 0.14 | Resists wear well; wear |
| | | | | scar only no penetration |
| | | | | to substrate at all |
| | | | | loads. |

### EXAMPLE 8

### Wear Rates of a Range of Different Coatings

A range of different coatings were prepared by processes analogous to those described above and the time to wear through 25 μm of the coatings under a 250N load was measured. Results are recorded in FIG. 1 from which it will be noted that a coating comprising 90 wt % polyetheretherketone and 10 wt % PFA did not wear through under the conditions of the test. The aforesaid coating was superior over a coating comprising 100% polyetheretherketone and far superior over various other fluoropolymers tested. For example respective 25 μm coatings comprising PVDF and ECTFE wore through in under 2 seconds, whereas the polyetheretherketone/PFA coating had not worn through after greater than 14 minutes.

### EXAMPLE 9

### Comparison of Coatings with Varying Levels of PFA

Coatings were prepared as described above having varying levels of polyetheretherketone and PFA and such coatings were compared to respective coatings comprising pure PTFE, PFA and polyetheretherketone. Results are summarised in FIG. 2 which shows the coefficients of friction of various coatings under 50N, 100N and 250N loads. It will be noted that the coefficient of friction for polyetheretherketone/PFA coatings is, in all cases, less than that for pure PFA and pure polyetheretherketone coatings. Also, the coefficient of friction for the majority of polyetheretherketone/PFA coatings is less than that for PTFE which is generally regarded as one of the lowest coefficient of friction fluoropolymers available.

### EXAMPLE 10

### Preparation of Materials for Scratch Resistance Testing

Using the method generally described in Example 1 polyetheretherketone and/or fluoropolymer dispersions were prepared having compositions described in Table 3.

TABLE 3

| | Identify and | | |
|---|---|---|---|
| | amount (wt %) of | Identify and amount | |
| Example No | polyetheretherketone | (wt %) of fluoropolymer | |
| 10a | PAEK No. 1 (100 wt %) | — | |
| 10b | PAEK No 1 (90 wt %) | ZonylMP1400 | (10 wt %) |
| 10c | PAEK No 1 (70 wt %) | ZonylMP1400 | (30 wt %) |
| 10d | PAEK No 1 (70 wt %) | ZonylMP1400 | (30 wt %) *1 |
| 10e | PAEK No 1 (90 wt %) | PFA5011 | (10 wt %) |
| 10f | PAEK No 1 (70 wt %) | PFA5011 | (30 wt %) *1 |

*1 contains a small amount of black pigment.

The compositions described in Table 3 were coated, generally using the method of Example 5a, onto 100 mm×100 mm×3 mm stainless steel plaques which had previously been degreased and grit blasted with aluminium oxide.

### EXAMPLE 11

### Scratch Resistance Testing

Plaques coated with the formulations described in Example 10 and other engineering thermoplastics and fluoropolymers were tested for scratch resistance using a Sheen Scratch Tester. A test plaque is clamped to a slide which slowly withdraws the panel while a 1 mm tungsten carbide tip scratches the surface. The test was conducted using a single specified load of 6 kg. The scratch test was carried out under similar conditions to IS01518; however as the speed of the needle could not be measured on the equipment the test should be regarded as comparative only.

The results were determined by measurement of the average scratch width in mm by light microscopy and the peak valley in μm across the scratch using a Form Tallysurf Intra Measuring Instrument.

Scratch width was determined by measuring the scratch width under 30× magnification using an Olympus SZH10 microscope. The scratch width is measured in the centre of the scratch and 10 mm either side of centre, and an average width calculated from the three readings.

Scratch depth was determined using a Form Tallysurf Intra Measuring Instrument. A stylus is pulled over the scratch and a reading of the surface roughness can be measured. The Pv (peak valley) is also shown, this being a measure in μm of the lowest valley present in the measured coating. Before the Pv can be measured the Tallysurf equipment removes any shape or slope present in the test panel to give a mean average line; therefore the Pv is a measure of the lowest peak to a mean average line.

Results are provided in Table 4.

TABLE 4

| | | | Peak | |
|---|---|---|---|---|
| | | Dry film | valley | Average |
| | Identity | thickness | (μm) Depth | scratch |
| Example No | of Coating | (μm) | of scratch | width (mm) |
| 11a | 10a | 44 | 4.16 | 0.71 |
| 11b | 10b | 50 | 8.41 | 0.73 |
| 11c | 10c | 40 | 4.07 | 0.85 |
| 11d | 10d | 40 | 5.00 | 0.72 |
| 11e | 10e | 55 | 6.00 | 0.75 |
| 11f | 10f | 55 | 14.15 | 0.65 |
| 11g | RYTON | 423 | 21.64 | 0.99 |
| 11h | ETFE | 446 | 26.74 | 1.13 |
| 11i | PFA | 214 | 28.16 | 1.11 |
| 11j | PVDF | 1240 | 34.75 | 1.07 |
| 11k | PTFE | 44 | 35.65 | 0.98 |
| 11l | OXPEKK | 570 | 35.68 | 1.00 |
| 11m | ECTF | 911 | 43.83 | 1.16 |
| 11n | FEP | 74 | 71.9 | 1.09 |

Examples 11g, 11h, 11i, 11j, 11l and 11m were applied by electrostatic powder coating methodology generally as described in Example 5b.

The coatings of Examples 11k and 11n were found, under the test conditions, to have scratched through to the underlying substrate.

From a consideration of the results in Table 4, it will be noted that each of Examples 11b to 11f show excellent scratch resistance compared to other materials tested in Examples 11g to 11n. Also, Examples 11b to 11f have comparable performance to the material of Example 11a even though the materials of Examples 11b to 11f included fluoropolymers which are generally regarded as significantly softer in comparison to the material in Example 11a.

It should now be appreciated that coatings comprising a polyaryletherketone such as polyetheretherketone and a fluoropolymer such as PFA, show surprisingly low wear as determined, for example, by wear rates (see Example 8) and by scratch resistance (see Example 11) and low coefficient of friction compared to coatings comprising polyaryletherketone or fluoropolymer alone. Such coatings may be used to coat parts which are subjected to abrasive forces which may abrade and/or scratch their surfaces, in use, for example by virtue of contact with abrasive fluids such as abrasive slurries or by virtue of contact with other solids for example other metals or plastics materials. Furthermore, since polyaryletherketones have excellent resistance to chemicals and heat, the coatings described may be used in relatively harsh environments whilst still maintaining excellent wear properties.

The invention is not restricted to the details of the foregoing embodiments). The invention extends to any novel one, or any novel combination, of the features disclosed in this specification (including any accompanying claims, abstract and drawings), or to any novel one, or any novel combination, of the steps of any method or process so disclosed.

1. An assembly comprising a part arranged to be contacted by wear means in use such that said wear means has a tendency to apply an abrasive force to an outer surface of said part, wherein said outer surface of said part comprises a composition which comprises a polyaryletherketone polymer and a fluoropolymer.

2. An assembly according to claim 1, wherein said polyaryletherketone polymer comprises a repeat unit of formula 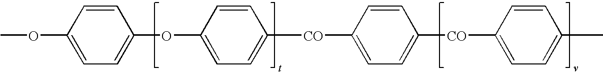
where t and v independently represent 0 or 1.

3. An assembly according to claim 1, wherein said polyaryletherketone polymer is polyetheretherketone.

4. An assembly according to claim 1, wherein said fluoropolymer comprises a fluorocarbon resin selected from perfluoroalkoxy tetrafluoroethylene (PFA), polytetrafluoroethylene (PTFE) and tetrafluoroethylene-hexafluoropropylene copolymer resin (FEP).

5. An assembly according to claim 1, wherein the ratio of the wt % of polyaryletherketone to the wt % of fluoropolymer in said composition at said outer surface is at least 1 and is less than 50.

6. An assembly according to claim 5, wherein said ratio is in the range 2 to 9.

7. An assembly according to claim 1, wherein the composition at said outer surface includes at least 40 wt % and 95 wt % or less of said polyaryletherketone.

8. An assembly according to claim 1, wherein the composition at said outer surface includes at least 60 wt % of said polyaryletherketone.

9. An assembly according to claim 1, wherein the composition at said outer surface includes at least 5 wt % fluoropolymer.

10. An assembly according to claim 1, wherein the composition of said outer surface includes at least 10 wt % of said fluoropolymer.

11. An assembly according to claim 1, wherein the composition of said outer surface includes 70 to 95 wt % of said polyaryletherketone and 5 to 30 wt % of said fluoropolymer.

12. An assembly according to claim 1, wherein said part comprises a layer of said composition which layer defines said outer surface of said part.

13. An assembly according to claim 12, wherein said layer has a coat weight of at least 1.0 mg/cm² and less than 20 mg/cm², at least 1.0 mg of said polyaryletherketone per cm² and less than 20 mg of said polyaryletherketone per cm².

14. An assembly according to claim 1, wherein said part is for an item of cookware, bakeware, domestic appliance, industrial apparatus or automotive application.

15. An assembly according to claim 1, wherein said part comprises a bearing surface.

16. An assembly according to claim 12, wherein said layer is in direct contact with a metal surface of said part.

17. An assembly according to claim 1, wherein said wear means comprises an abrasive fluid which contacts said outer surface of said part or a solid part which contacts said outer surface.

18. A method of manufacturing a part of an assembly which is arranged to be subjected to a wear means in use such that said wear means has a tendency to apply an abrasive force to an outer surface of said part, said method comprising providing said part with an outer surface which comprises a composition which comprises a polaryletherketone polymer and a fluoropolymer.

19. A part for an assembly, said part being arranged to be contacted in use by a wear means such that said wear means has a tendency to apply an abrasive force to an outer surface of said part to abrade it, wherein said outer surface of said part comprises a composition which comprises a polyaryletherketone polymer and a fluoropolymer.

20. The use of a composition which comprises a polyaryletherketone polymer and a fluoropolymer in the manufacture of a part which is contacted by a wear means in use which wear means has a tendency to apply an abrasive force to an outer surface of said part to abrade it.

21. A method of operating an assembly which comprises a part having an outer surface which comprises a composition which comprises a polyaryletherketone polymer and a fluoropolymer, said method comprising contacting a wear means with said outer surface of said part wherein said wear means applies an abrasive force to said outer surface.

22. An operative assembly comprising a part which is contacted with a wear means which applies an abrasive force to an outer surface of said part, wherein said outer surface of said part comprises a composition which comprises a polyaryletherketone polymer and a fluoropolymer.

23. An assembly as claimed in claim 1, which comprises 70 to 95 wt % polyetheretheketone and 5 to 30 wt % PFA.

24. An assembly according to claim 23, wherein said part comprises a layer of said composition which layer defines said outer surface of said part, wherein said layer has a coat weight of at least 1.0 mg/cm² and less than 20 mg/cm² at least 1.0 mg of said polyaryletherketone per cm² and less than 20 mg of said polyaryletherketone per cm².
